(19) United States
(12) Patent Application Publication
(10) Pub. No.: US 2012/0240402 A1
(43) Pub. Date: Sep. 27, 2012

(54) MANUFACTURING METHOD FOR BOTTOM COVER HEAT EXCHANGING ASSEMBLY OF WATER HEATER AND SPECIAL TOOL THEREOF

(75) Inventors: Yougen Zhang, Nanjing (CN); Shouju Lin, Nanjing (CN); Xiaoping Zhang, Nanjing (CN); Maosong Liu, Nanjing (CN)

(73) Assignee: A. O. SMITH (CHINA) WATER HEATER COMPANY LTD., Nanjing (CN)

(21) Appl. No.: 13/514,679

(22) PCT Filed: Nov. 29, 2010
(86) PCT No.: PCT/CN10/01915

§ 371 Date: Jun. 8, 2012

(30) Foreign Application Priority Data
Dec. 8, 2009 (CN) 200910232596.7

(51) Int. Cl. B23P 15/26; B23P 23/04

(52) U.S. Cl. 29/890.054; 29/727

(57) ABSTRACT

A manufacturing process of a heat-exchange assembly of a water heater bottom cover is disclosed. The process comprises the following steps: after blanking, the bottom cover (1) and a bottom cap (2) are stretched respectively, each of which is composed of a spherical surface and a cylindrical section; vitreous enamel is painted on the surfaces of said bottom cover other than the inner surface of its cylindrical section and the convex surface of the bottom cap other than the outer surface of its cylindrical section, and the vitreous enamel is sintered and cured; the bottom cover is put onto the bottom cap, until the inner surface of the cylindrical section of the bottom cover completely and closely contacts with the outer surface of the cylindrical section of the bottom cap; and fillet welding is performed along the edge of the bottom cap's cylindrical section which is pressed on the bottom cover's cylindrical section, to make the bottom cover and the bottom cap form the heat-exchange assembly of the bottom cover with a heat exchange cavity. A special tooling used for the process is further disclosed. The process may make the heat-exchange assembly of the bottom cover have high strength and rigidity and have excellent air-tightness and corrosion resistance.

### TECHNICAL FIELD

The present invention relates to a manufacturing process of a water heater shell, in particular to a manufacturing process of a heat-exchange assembly of a water heater bottom cover, and at the same time relates to special tooling. The present invention belongs to the technical field of manufacturing of a water heater.

### BACKGROUND ART

A solar water heater exchanging heat by a bottom cover is a solar water heater with totally new structures (its detailed information may be found in the China patent application No.200810196064.8 and application No. 200820185858.X titled Pressurized Solar Water Heater and filed by the same applicant), and its basic structural characteristic is that the bottom of its cylindrical water storage tank is welded with the heat-exchange assembly of a bottom cover composed of a bottom cover and a bottom cap. In operation, the non-pressurized circulating water in the heat-exchange assembly of a bottom cover is first heated by the solar energy, and then the heat is transferred to the pressurized cold water in the water storage tank through the bottom cover of the heat-exchange assembly of a bottom cover to heat the cold water. Because this kind of water heater has a high heat exchange efficiency and a low manufacture cost and allows for more comfortable bathing, it has a good market prospect.

However, to manufacture its key component, i.e. the heat-exchange assembly of a bottom cover, is quite difficult. To prevent corrosion and avoid scale deposit, the double surfaces of the bottom cover and the convex surface of the bottom cap which contact with water need to be painted with vitreous enamel, thus in the process of manufacturing the heat-exchange assembly of a bottom cover, its strength and air-tightness must be ensured and the enameled surfaces must be protected from being damaged in welding.

### SUMMARY OF THE INVENTION

The object of the present invention is to put forward a manufacturing process of a heat-exchange assembly of a water heater bottom cover and a special tooling, to solve the difficulty in manufacturing a solar water heater exchanging heat by a bottom cover once and for all, which may not only ensure the heat-exchange assembly of the bottom cover to have required strength, rigidity and ideal air-tightness, but also ensure enough corrosion resistance at the same time.

To achieve the above-mentioned object, the manufacturing process of a heat-exchange assembly of a water heater bottom cover and the special tooling of the present invention comprise the following steps:

Step one of shaping: after blanking, the bottom cover and a bottom cap are stretched respectively, each of which is composed of a spherical surface and a cylindrical section, wherein the joint of said spherical surface and the cylindrical section is arc transition; the spherical surface curvature radius of said bottom cover is smaller than the spherical surface curvature radius of the bottom cap, and the inner diameter of the cylindrical section of the bottom cover matches with the outer diameter of the cylindrical section of the bottom cap; and the cylindrical section length of said bottom cover is longer than the cylindrical section length of the bottom cap;

Step two of painting: vitreous enamel is painted on the surfaces of said bottom cover excluding the inner surface of its cylindrical section and the convex surface of the bottom cap excluding the outer surface of its cylindrical section, and the vitreous enamel is sintered and cured (the part which need not vitreous enamel may be covered before painting or may be cleaned by blowing after painting), wherein in general, the enamel thickness of the concave surface of the bottom cover is controlled within 100 μm-200 μm, the enamel thickness of the convex surface of the bottom cover is controlled within 180 μm-360 μm, and the enamel thickness of the convex surface of the bottom cap is controlled within 180 μm-360 μm;

Step three of composing: the bottom cover is put onto the bottom cap with their spherical surfaces in the same convex direction, until the inner surface of the cylindrical section of the bottom cover completely and closely contacts with the outer surface of the cylindrical section of the bottom cap; and

Step four of welding: fillet welding is performed along the edge of the bottom cap's cylindrical section which is pressed on the bottom cover's cylindrical section, to make the bottom cover and the bottom cap form the heat-exchange assembly of the bottom cover with a heat exchange cavity.

A further improvement of this invention is that in said step one, the transition arc radius of said bottom cover is bigger than the transition arc radius of the bottom cap.

The above process and special tooling, combined with the structure design of the bottom cover and the bottom cap, not only make the inner surface of the cylindrical section of the bottom cover and the outer surface of the cylindrical section of the bottom cap completely and closely contact with each other and form an air-tight structure, but also make the enamel surfaces of the bottom cover and the bottom cap fit with each other and ensure all the surface of the heat exchanging cavity to be enameled, thereby having ideal corrosion resistance and scale prevention effect. Therefore, it may be said that this invention solves the air-tight and welding problem of the bottom cover and bottom cap through appropriate painting of vitreous enamel without damage to the vitreous enamel coating and corrosion resistance; and the heat-exchange assembly of the bottom cover not only satisfies strength and rigidity requirements, but also has excellent air-tightness and corrosion resistance.

The above-mentioned step three requires control of the joint depth after joint to ensure that the vitreous enamel of the bottom cover and the bottom cap is not damaged. Thus, the adopted special tooling is composed of an upper die and a lower die which may move toward each other, wherein said lower die has an upward convex locating surface for the bottom cap; there is a guide cone along the perimeter of said locating surface for the bottom cap, to guide the perimeter of the bottom cover to be put outside the bottom cap; the depth of said guide cone is limited to make the inner surface of the cylindrical section of the bottom cover completely and closely contact with the outer surface of the cylindrical section of said bottom cap; and said upper die has a locking block fixed thereon, which is form-fitting with the surface of said bottom cover.

When the composing step is finished, the bottom cap is put onto the locating surface of the lower die, and then the bottom cover is put onto the bottom cap, to guide its perimeter into the guide cone. Then, the upper and lower dies are joined, so the bottom cover will be put onto the bottom cap and the inner surface of the cylindrical section of the bottom cover will be completely and closely contacted with the outer surface of the cylindrical section of the bottom cap.

### BRIEF DESCRIPTION OF THE DRAWINGS

Further descriptions of the present invention are given below in combination with the Drawings.

FIG. 1 is a shaping procedure diagram of an embodiment of the present invention.

FIG. 2 is a painting procedure diagram of the embodiment of FIG. 1.

FIG. 3 is a composing procedure diagram of the embodiment of FIG. 1.

FIG. 4 is a welding procedure diagram of the embodiment of FIG. 1.

FIG. 5 is a special tooling structural diagram of the embodiment of FIG. 1.

### DETAILED DESCRIPTION

### Embodiment 1

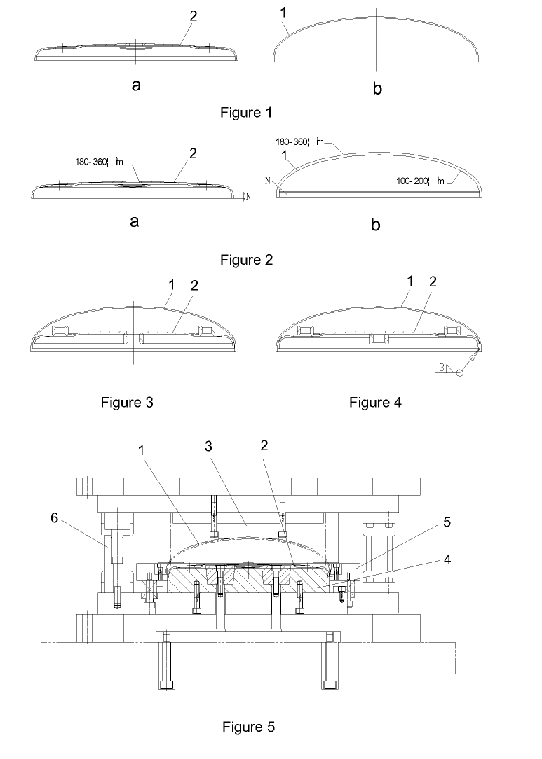

The manufacturing processes of the heat-exchange assembly of bottom cover of the present embodiment are shown in FIG. 1 to FIG. 4, comprising the following steps:

Step one of shaping: after blanking, a bottom cover 1 (b in FIG. 1) and a bottom cap 2 (a in FIG. 1) are stretched respectively, each of which is composed of a spherical surface and a cylindrical section, wherein the joints of the spherical surfaces and the cylindrical sections of the bottom cover 1 and the bottom cap 2 are all arc transitions; the spherical surface curvature radius of the bottom cover 1 is smaller than the spherical surface curvature radius of the bottom cap 2, and the inner diameter of the cylindrical section of the bottom cover 1 matches with the outer diameter of the cylindrical section of the bottom cap 2; the cylindrical section length of the bottom cover 1 is longer than the cylindrical section length of the bottom cap 2; and the transition arc radius of the bottom cover 1 is bigger than the transition arc radius of the bottom cap 2;

Step two of painting: an inner surface N of the cylindrical section of the bottom cover 1 (b in FIG. 2) and an outer surface N of the cylindrical section of the bottom cap 2 (a in FIG. 2) are covered respectively, and then vitreous enamel is painted on the other surfaces of the bottom cover 1 and the bottom cap 2, wherein in order to ensure the service life and the pressure bearing function of the enameled water storage tank and considering that the convex surface of the bottom cover 1 is a part of the water storage tank and bears pressure while the concave surface of the bottom cover, which is a part of the heat exchange cavity, doesn't bear pressure, the concave surface's enamel thickness of the bottom cover is controlled within 100 μm-200 μm and the convex surface's enamel thickness of the bottom cover is controlled within 180 μm-360 μm, and the convex surface's enamel thickness of the bottom cap is controlled within 180 μm-360 μm; thereafter, sintering and curing are performed;

Step three of composing: the bottom cover 1 is put onto the bottom cap 2 with their spherical surfaces in the same convex direction, until the transition arc of the bottom cover 1 closely contacts with the transition arc edge of the bottom cap 2 (referring to FIG. 3); and

Step four of welding: fillet welding is performed along the edge of the cylindrical section of the bottom cap 2 which is pressed on the cylindrical section of the bottom cover 1, to make the bottom cover 1 and the bottom cap 2 form the heat-exchange assembly of the bottom cover with a heat exchange cavity (referring to FIG. 4).

A special tooling for carrying out the above step three of the manufacturing process is shown in FIG. 5, and is composed of an upper die 3 and a lower die 4 which may move toward each other. The lower die 4 has an upward convex locating surface for the bottom cap; a locating and guiding block 5 for the bottom cover is fixed along the perimeter of the locating surface of the bottom cap; there is a guide cone in the middle of the locating and guiding block 5 for the bottom cover to guide the perimeter of the bottom cover to be put outside the bottom cap; and the depth of the guide cone is limited to make the inner surface of the cylindrical section of the bottom cover completely and closely contact with the outer surface of the cylindrical section of the bottom cap after assembly. The upper die 3 has a concave-up locking block made of polyurethane gum fixed thereon which is form-fitting with the bottom cover's surface, and outside the upper die 3, there is a stop block 6 to limit the downward depth.

In assembly, the bottom cap 2 is put into the lower die 4 to be fixed at first, and then the bottom cover 1 is put into the guide cone of the locating and guiding block 5 of the lower die, to make the bottom cover 1 automatically align with the earlier fixed bottom cap 2 concentrically in the die. Then, the bottom cover 1 is pressed down onto the bottom cap 2 by lowering down the upper die with the concave-up locking block made of polyurethane gum along with the equipment, until the inner surface of the cylindrical section of the bottom cover completely and closely contacts with the outer surface of the cylindrical section of the bottom cap. The guide cone and the stop blocks in the die limit the downward depth, which ensures the air-tightness of the bottom cap entering the bottom cover as well as prevents vitreous enameled surfaces from being damaged as the bottom cover is pressed down onto the bottom cap.

Practice proves that adopting the process of this embodiment may manufacture a high quality solar water heater exchanging heat by a bottom cover. Compared with existing similar water heaters, these new water heaters do not deposit scale and have higher heat exchange efficiency; and compared with water heaters having stainless steel water storage tanks, the manufacturing cost is much lower.

1. A manufacturing process of a heat-exchange assembly of a water heater bottom cover, comprising the following steps:
Step one of shaping: after blanking, the bottom cover and a bottom cap are stretched respectively, each of which is composed of a spherical surface and a cylindrical section, wherein the joint of said spherical surface and the cylindrical section is arc transition; the spherical surface curvature radius of said bottom cover is smaller than the spherical surface curvature radius of the bottom cap, and the inner diameter of the cylindrical section of the bottom cover matches with the outer diameter of the cylindrical section of the bottom cap; and the cylindrical section length of said bottom cover is longer than the cylindrical section length of the bottom cap;
Step two of painting: vitreous enamel is painted on the surfaces of said bottom cover excluding the inner surface of its cylindrical section, and the convex surface of the bottom cap excluding the outer surface of its cylindrical section, and the vitreous enamel is sintered and cured;
Step three of composing: the bottom cover is put onto the bottom cap with their spherical surfaces in the same convex direction, until the inner surface of the cylindrical section of the bottom cover completely and closely contacts with the outer surface of the cylindrical section of the bottom cap; and
Step four of welding: fillet welding is performed along the edge of the bottom cap's cylindrical section, which is pressed on the bottom cover's cylindrical section, to make the bottom cover and the bottom cap form the heat-exchange assembly of the bottom cover with a heat exchange cavity.

2. The manufacturing process of a heat-exchange assembly of a water heater bottom cover according to claim 1, characterized in that: in said step one, the transition arc radius of said bottom cover is bigger than the transition arc radius of the bottom cap.

3. The manufacturing process of a heat-exchange assembly of a water heater bottom cover according to claim 2, characterized in that: in said step two, the enamel thickness of the concave surface of the bottom cover is controlled within 100 μm-200 μm, and the enamel thickness of the convex surface of the bottom cover is controlled within 180 μm-360 μm.

4. The manufacturing process of a heat-exchange assembly of a water heater bottom cover according to claim 3, characterized in that: the enamel thickness of the convex surface of said bottom cap is controlled within 180 μm-360 μm.

5. A special tooling used for carrying out the manufacturing process of claim 1, characterized in that: the special tooling is composed of an upper die and a lower die which may move toward each other, wherein said lower die has an upward convex locating surface for the bottom cap; there is a guide cone along the perimeter of said locating surface for the bottom cap, to guide the perimeter of the bottom cover to be put outside the bottom cap; the depth of said guide cone is limited to make the inner surface of the cylindrical section of the bottom cover completely and closely contact with the outer surface of the cylindrical section of said bottom cap; and said upper die has a locking block fixed thereon, which is form-fitting with the surface of said bottom cover.

6. The special tooling according to claim 5, characterized in that: a locating and guiding block for the bottom cover is fixed along the perimeter of the locating surface for the bottom cap of said lower die; and there is a guide cone in the middle of said locating and guiding block for the bottom cover, to guide the perimeter of the bottom cover to be put outside the bottom cap.

7. The special tooling according to claim 6, characterized in that: said concave-up locking block is made of polyurethane gum.
